(19) United States
(12) Patent Application Publication
(10) Pub. No.: US 2025/0087212 A1
(43) Pub. Date: Mar. 13, 2025

(54) INTELLIGENT RESPONSE RECOMMENDATION SYSTEM AND METHOD FOR REAL-TIME VOICE COUNSELING SUPPORT

(71) Applicant: Bespin Global Inc., Seoul (KR)

(72) Inventors: Dong Hyeog LIM, Seoul (KR); Jae Hyeong AN, Anyang-si (KR); Joon Soo HONG, Anyang-si (KR); Bo Min KWON, Seoul (KR)

(73) Assignee: Bespin Global Inc., Seoul (KR)

(21) Appl. No.: 18/956,063

(22) Filed: Nov. 22, 2024

Related U.S. Application Data
(63) Continuation of application No. PCT/KR2023/007093, filed on May 24, 2023.

(30) Foreign Application Priority Data
May 24, 2022 (KR) 10-2022-0063183

(51) Int. Cl. G10L 15/22; G06F 16/93; G10L 15/00; G10L 15/26; H04M 3/51

(52) U.S. Cl. CPC G10L 15/22; G10L 15/005; G10L 15/26; H04M 3/51; G06F 16/93

(57) ABSTRACT

The present disclosure relates to an intelligent response recommendation system for real-time voice counseling support and a method thereof. In responding to a customer's question by a customer service representative, the system is configured to: extract voice data of a voice call between a first terminal of the customer and a second terminal of the customer service representative and convert the extracted voice data into test data; and search a database for a sentence recognized through linguistic analysis of the text data so as to generate a response to the customer's question, and the customer's speech collected in real time is recognized as a sentence and searched for on the basis of an artificial intelligence language model so that an appropriate response to the customer's question may be derived and recommended in real time, and an accurate and detailed response may be derived regardless of the customer service representative's knowledge or experience, thus providing high-quality customer service.

### TECHNICAL FIELD

The present disclosure relates to an intelligent response recommendation system and method for real-time voice counseling support that supports a customer service representative by analyzing a customer's question by voice and recommending a response to the question when the customer service representative responds to the customer's question.

### BACKGROUND ART

Recently, many companies including public institutions are making various attempts to automate a customer call center counseling task.

For example, there is a system that applies chatbots and voicebots that can automatically response a customer's question. In addition, an agent assist being a response recommendation system for counseling support customer service representative the chatbots and the voicebots is being introduced.

When a customer counseling system requires responses to an unspecified number of inquiries in addition to a specialized customer service representative in charge of a designated task, or when a customer service representative with low expertise conducts counseling due to frequent movement of counseling personnel, a highly accurate search engine is required to increase the accuracy of the responses. In addition, the customer counseling system requires a function of recommending a response suitable for a customer's question.

A related technology includes Korean Patent No. 10-2339794 entitled “Apparatus and Method for Serving Question and Answer”.

In order to recommend a response, the customer counseling system may receive a response to a customer's inquiry directly, which is input by a customer service representative, from an agent assist, but since it takes a certain amount of time to respond to a customer, it is difficult to provide an immediate response recommendation.

In addition, a voice recognition technology may be applied, but a load increases and a processing speed is limited in a series of processes of extracting text from voice, searching for the text through a search engine, deriving related responses, and finally recommending one of the responses to the customer service representative.

Accordingly, a response recommendation system that can quickly and accurately derive and recommend a response by applying a voice recognition technology and integrating a call processing technology, a media processing technology, and an AI technology is needed.

### DISCLOSURE

### Technical Problem

The present disclosure is directed to providing an intelligent response recommendation system for real-time voice counseling support that provides a technology for controlling a call so that a customer service representative can extract voice for a customer's question in responding to the customer's question and sharing voice received in real time through multiple channels and a method thereof.

In addition, the present disclosure is directed to providing an intelligent response recommendation system and real-time voice counseling support that derives and recommends a response appropriate for a customer's question by converting the customer's question into text through voice recognition, recognizing a sentence based on an artificial intelligence language model, and searching for the sentence and a method thereof.

### Technical Solution

In order to achieve the objects, an intelligent response recommendation system for real-time voice counseling support according to the present disclosure includes: a first terminal to which voice of a user is input; a call center system that allocates a second terminal to the first terminal to connect a call between the first terminal and the second terminal, and extracts voice data from a voice call between the first terminal and the second terminal; a media gateway that performs circuit switching with the call center system and shares the voice data; a STT server that converts the voice data received from the media gateway into text data; a third terminal that is connected to the second terminal, and receives the text data and displays response data corresponding to the text data in a state in which the call between the first terminal and the second terminal is connected; and a support server that analyzes the text data received from the third terminal to recognize a language, generates the response data corresponding to the language recognized from the text data, and transmits the response data to the third terminal.

The intelligent response recommendation system for real-time voice counseling support further includes a relay server connected to the media gateway and transmitting the text data converted by the STT server to the third terminal, and the media gateway transmits the voice data to the STT server to request text conversion, and transmits the text data converted by the STT server to the relay server.

The STT server analyzes the voice data, converts customer voice data input through the first terminal into customer text data, converts voice data of a customer service representative input through the second terminal into counselor text data, and transmits the text data.

The support server analyzes a meaning included in the text data, searches for information on the text data, and generates the response data based on search results.

The support server generates a recommended response based on a search result corresponding to the meaning included in the text data among the search results, and transmits the recommended response to the third terminal as the response data.

When a document recommended according to a search result for a question included in the text data is included in the preset question-response data, the support server transmits the response data for the question to the third terminal.

When a document recommended according to a search result for a question included in the text data is a general document, the support server generates the response data comprising a plurality of responses and transmits the response data to the third terminal.

The support server maps a question included in the text data and the derived response data, stores the mapped data in a database, and calculates statistics on the question and a response.

When an acknowledgement for the response data is received, the support server matches the acknowledgement to the response data and stores the matched data in the database.

The support server includes: a query classifier that classifies a sentence type of data into one of a keyword, an interrogative sentence, a plain text, and an exclamation sentence based on analysis results of the text data; a keyword search engine that searches for data classified into the keyword by the query classifier and recommends a document; a natural language search engine that searches for data classified into the interrogative sentence by the query classifier and recommends a document; a response generation engine that extracts a response corresponding to a meaning included in the text data from the document recommended by one of the keyword search engine and the natural language search engine; and a response generator that generates the response data based on the response extracted by the answer generation engine.

The support server uses sentence bidirectional encoder representations from transformers (SBERT) being an artificial intelligence language model as a pre-learning language model, embeds sentences into specific vector values understandable by a computer in accordance with contextual and semantic characteristics of data included in the text data, measures a similarity between the sentences, and recognizes a language of the text data.

The support server uses a sentence BERT (SBERT) model being a language model and a machine reading comprehension (MRC) model being a machine reading comprehension model, searches for a document corresponding to a question or a keyword included in the text data, and generates response data based on search results.

An intelligent response recommendation method for real-time voice counseling support according to the present disclosure includes: a step of extracting voice data for a voice call by connecting a first terminal and a second terminal through a communication network; a step of converting the voice data into text data; a step of transmitting the text data to a third terminal connected to the second terminal; a step in which the support server receiving the text data from the third terminal analyzes the text data and recognizes a language; a step of searching data for a question or a keyword included in the text data according to a language recognition result; a step of generating response data based on search results; and a step in which the third terminal receives and displays the response data.

The step of recognizing a language includes: a step of refining unnecessary text from the text data; a step of classifying a sentence type for a sentence or a word included in the text data; and a step of analyzing morphemes of the text data.

The step of recognizing a language includes: a step of analyzing the text data and classifying the data into one of a keyword, an interrogative sentence, a plain text, and an exclamation sentence; and a step of ignoring data other than the keyword and the interrogative sentence and analyzing next data.

The step of searching data includes: a step of recommending a document by searching for data classified into the keyword; and a step of recommending a document by searching for data classified into the interrogative sentence.

In the step of generating response data, a recommended response is generated based on a search result corresponding to a meaning included in the text data among a plurality of search results.

In the step of generating response data, when a document recommended according to the search result is a preset question-and-answer data, a response corresponding to the question is generated as the response data.

In the step of generating response data, when a document recommended according to the search result is a general document, the response data comprising a plurality of responses is generated.

The operation method of an intelligent response recommendation system for real-time voice counseling support further includes: a step in which the support server maps the question included in the text data and the derived response data and storing the mapped data in a database; a step of, when an acknowledgement for the response data is received, matching the acknowledgement to the response data and storing the matched data; and a step of calculating statistics on the question and a response.

### Advantageous Effects

According to an aspect, an intelligent response recommendation system for real-time voice counseling support and a method thereof of the present disclosure can derive and recommend a response appropriate for a customer's question by converting the customer's question into text through voice recognition, classifying the text into keywords and natural language based on a language model, and searching the keywords and natural language through a search engine to derive a response.

According to an aspect of the present disclosure, it is possible to provide a high-quality counseling service by deriving an accurate and detailed response regardless of the knowledge or experience of a customer service representative, and to shorten the training time for the customer service representative.

In addition, the present disclosure can easily analyze s voice of customer (VOC) based on the relationship between a customer and question content based on counseling content and quickly respond.

Effects of the present disclosure are not limited to the above-described effects, and other effects that are not mentioned will be able to be clearly understood by those skilled in the art from the following description.

### DESCRIPTION OF DRAWINGS

FIG. 1 is a block diagram illustrating the configuration of an intelligent response recommendation system for real-time voice counseling support according to an embodiment of the present disclosure.

FIG. 2A, FIG. 2B, and FIG. 2C are flowcharts showing a process of transmitting voice in the intelligent response recommendation system for real-time voice counseling support according to an embodiment of the present disclosure.

FIG. 3A and FIG. 3B are flowcharts illustrating a process of transmitting and sharing voice in the intelligent response recommendation system for real-time voice counseling support according to an embodiment of the present disclosure.

FIG. 4 is a diagram for reference in explaining a channel-specific voice data processing process of the intelligent response recommendation system for real-time voice counseling support according to an embodiment of the present disclosure.

FIG. 5 is a flowchart illustrating a recommendation response processing process of the intelligent response recommendation system for real-time voice counseling support according to an embodiment of the present disclosure.

FIG. 6 is a diagram for reference in explaining an input query classification process of the intelligent response recommendation system for real-time voice counseling support according to an embodiment of the present disclosure.

FIG. 7 is a diagram for reference in explaining a document recommendation process through keyword search of the intelligent response recommendation system for real-time voice counseling support according to an embodiment of the present disclosure.

FIG. 8 is a diagram for reference in explaining a document recommendation process through natural language search of the intelligent response recommendation system for real-time voice counseling support according to an embodiment of the present disclosure.

FIG. 9 is a diagram for reference in explaining a response data generation process of the intelligent response recommendation system for real-time voice counseling support according to an embodiment of the present disclosure.

FIG. 10 is a diagram for reference in explaining a reference document storage process of the intelligent response recommendation system for real-time voice counseling support according to an embodiment of the present disclosure.

### DESCRIPTION OF REFERENCE NUMERALS

11: Customer phone terminal 12: Customer service representative terminal

13: Customer service representative PC 40: Media gateway
50: Support server 51: Query classifier
52: Natural language search engine 53: Response generation engine
54: keyword search engine 55: Response generator
60: Media server 61: STT
62: Text relay server 81: DB
82: Knowledge DB

### MODE FOR INVENTION

Hereinafter, the present disclosure will be described in detail with reference to the accompanying drawings.

In this process, the thicknesses of lines or the sizes of elements illustrated in the drawings may be exaggerated for the purpose of clarity and convenience of explanation. Furthermore, terms to be described below are terms defined in consideration of functions thereof in the present disclosure and may be changed according to the intention of a user or an operator, or practice. Accordingly, such terms should be defined on the basis of the disclosure over the present specification.

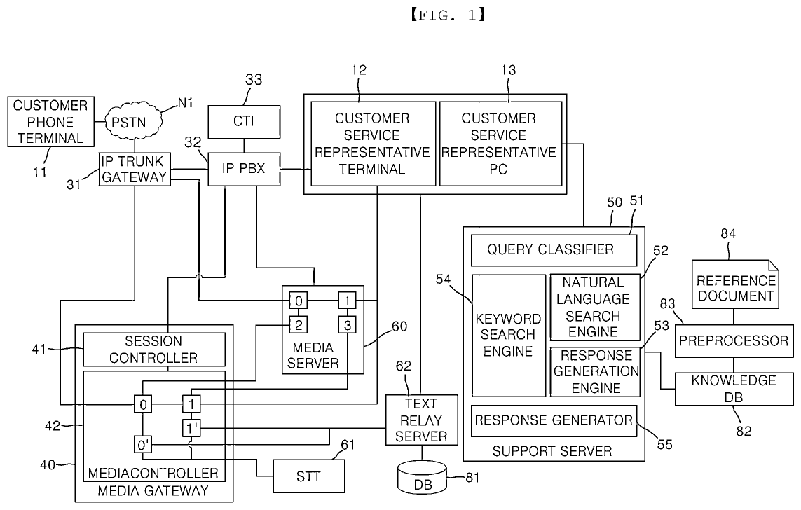

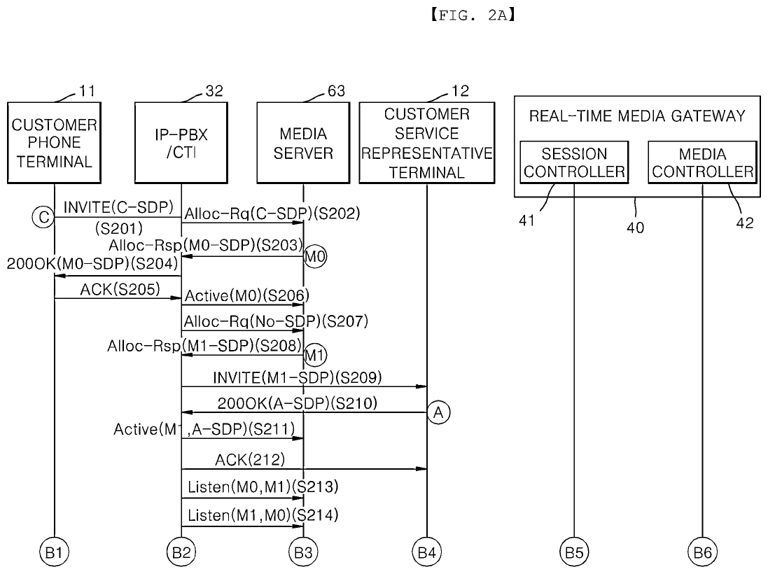

FIG. 1 is a block diagram illustrating the configuration of an intelligent response recommendation system for real-time voice counseling support according to an embodiment of the present disclosure.

As illustrated in FIG. 1, the intelligent response recommendation system of the present disclosure includes a customer phone terminal 11 being a first terminal, a customer service representative terminal 12 being a second terminal, a customer service representative PC 13 being a third terminal, an IP trunk gateway 31, an Internet protocol-private branch exchange (IP-PBX) 32, a media gateway 40, a support server 50, a media server 60, a speech-to-text (STT) 61, a text relay server 62, a database (DB) 81 being a first DB, and a knowledge database (DB) 82 being a second DB.

The response recommendation system may include a call center system in which a customer and a customer service representative are connected to a communication network, for example, a public switched telephone network, through the customer service representative terminal 12 and the customer phone terminal 11 to provide counseling and responses to a customer's request.

The call center system includes the IP trunk gateway 31, the IP-PBX 32, a CTI 33, the media server 60, the customer service representative terminal 12, and the customer service representative PC 13. The customer service representative terminal 12 is a terminal of the customer service representative, and the customer service representative PC 13 is a computer terminal of the customer service representative.

The response recommendation system connects to the STT 61 through the media server 60 and the media gateway 40 based on conversation content between the customer and the customer service representative in the call center system, converts voice into text, and receives a recommendation for a response to a question through the support server 50 based on the databases 81 and 82.

The communication network is a network of a communication service provider that provides a call connection between the call center system and the customer phone terminal 11 of the customer, and may include a public switched telephone network (PSTN) or a mobile communication network.

The customer phone terminal 11 is connected to the call center system through a communication network N1, for example, the public switched telephone network (PSTN). The customer phone terminal 11 connects a call session with the IP-PBX 32 in the call center system by using a general call connection method.

The customer service representative terminal 12 exchanges calls with the customer phone terminal 11 being the terminal of the customer connected to the communication network N1, outputs received voice of the customer, receives voice of the customer service representative, and transmits the received voice through the public switched telephone network so that the customer can receive the voice.

As the customer phone terminal 11 and the customer service representative terminal 12 wired telephones, wireless telephones, or portable terminals (mobile communication terminals) may be used. As the communication network N1, a public switched telephone network or a mobile communication network may be used.

The customer service representative PC 13 is a computer used when the customer service representative makes a voice call with the customer of the first terminal through the second terminal, and a personal computer (PC), a laptop, a tablet, a PDA, a smartphone, or the like may be used. The customer service representative may input customer counseling content and search related knowledge by operating the customer service representative PC 13 while making a voice call or video call with the customer phone terminal 11 of the customer through the customer service representative terminal 12.

The DB 81 may store customer information and text of the customer phone terminal 11. When the customer service representative PC 13 connects to the text relay server 62, the customer service representative PC 13 may retrieve the text from the DB 81 based on the customer information of the customer phone terminal 11.

The knowledge DB 82 is a database where knowledge data is stored. The knowledge DB 82 receives various types of data through a connected preprocessor 83 and stores the received data. When data is received through the preprocessor 83, the knowledge DB 82 adds new data or updates previously stored data.

The preprocessor 83 converts various forms of reference documents 84 and inputs the converted documents into the knowledge DB 82. The preprocessor 83 reconstructs the reference documents 84 into a form that is easy to be searched by the support server 50, and stores the reconstructed reference documents 84 in the knowledge DB 82.

The IP trunk gateway 31 is connected to the communication network.

The IP trunk gateway 31 maps a call center representative number assigned to the IP-PBX 32 and IP address information assigned to the IP-PBX 32, and stores the mapped information.

The IP-PBX 32 is connected between the IP trunk gateway 31 and the customer service representative terminal 12 and processes a call transmitted through the IP trunk gateway 31.

The IP-PBX 32 is a telephone switching network, and for example, an Internet protocol-private branch exchange (IP-PBX) supporting VOIP may be used.

The IP-PBX 32 may extract the voice of a customer received through the public switched telephone network. The IP-PBX 32 may use two methods for extracting voices: one for cases where the call center system includes the media server 60 and the other for cases where the call center system includes no media server 60.

### First: When the First Call Center System Includes the Media Server 60

A customer service representative is distributed to the IP-PBX 32 through a computer telephony integration (CTI) 33, the IP-PBX 32 performs line switching between the terminal 12 of the customer service representative. The CTI 33 is a system for processing computers and telephones by integrating them, and connects the customer service representative terminal 12 connected to the public switched telephone network and the customer service representative PC 13 being a computer so that data from the public switched telephone network is processed in conjunction with the computer.

In order to extract the voice of a customer received through the public switched telephone network and transmit the extracted voice to the media gateway 40, the IP-PBX 32 connects the customer's call and the customer service representative's call through the media server 60 so that voice data is transmitted through the media server 60.

In order to transmit voice data of the customer and voice data of the customer service representative to the media gateway 40, the IP-PBX 32 generates a new call to the media server 60 and performs line switching with the media gateway 40 by using the call.

The media server 60 is connected to the IP-PBX 32 and the media gateway 40.

The media server 60 shares the voice data of the customer by using a time slot, and transmits the voice data of the customer to the media gateway 40 through a channel connected to the media gateway 40.

The media server 60 shares the voice data of the customer service representative, and transmits the voice data of the customer service representative to the media gateway 40 through the channel connected to the media gateway 40.

Second: When the Second Call Center System does not Include the Media Server 60

The media gateway 40 may directly extract voice data between the customer phone terminal 11 and the customer service representative terminal 12.

The IP-PBX 32 routes a call requested from the IP trunk gateway 31 to the media gateway 40.

When a call is requested from the IP-PBX 32, the media gateway 40 allocates a channel to the customer phone terminal 11 and allocates a channel to the customer service representative terminal 12. In addition, in order to connect the channel of the customer phone terminal 11 and the channel of the customer service representative terminal 12, the media gateway 40 outbounds the call to the IP-PBX 32, including a counseling queue number.

A customer service representative is allocated for the call requested from the media gateway 40, and the IP-PBX 32 performs line switching with the customer service representative terminal 12.

When the line switching with the channel of the customer service representative terminal 12 is completed, the media gateway 40 completes the line switching with the channel of the customer phone terminal 11.

The media gateway 40 uses a time slot to share voice data of the customer and the customer service representative on a new channel.

The media gateway 40 can share voice data of the customer and voice data of the customer service representative when the call center system includes the media server 60 and when the call center system includes no media server 60. The media gateway 40 can share voice of the customer and voice of the customer service representative when the call center system includes the media server 60 and when the call center system does not include the media server 60.

When voice data extracted from a voice call between the customer service representative terminal 12 and the customer phone terminal 11 is received from the media server 60, the media gateway 40 transmits the received voice data to the STT 61 and requests data conversion.

The media gateway 40 is connected to the STT 61 that converts voice into text, and transmits the received voice data of the customer and the received voice data of the customer service representative to the STT 61.

The media gateway 40 receives text data converted from the voice data from the STT 61.

The voice data may be generated from the voice data of the customer phone terminal 11 and the voice data of the customer service representative terminal 12, respectively.

When the text data is received from the STT 61, the media gateway 40 transmits the text data about the voice of the customer and the text data about the voice of the customer service representative to the text relay server 62.

The STT 61 may convert voice into text based on a voice recognition technology. The STT 61 may provide services for voice conversation memo, conversation search, and VOC analysis.

The text relay server 62 is connected to the customer service representative PC 13 through a network, is connected to the media gateway 40, and is connected to the DB 81.

The text relay server 62 may relay text data. The text relay server 62 transmits the text data (conversation between the customer and the customer service representative) received from the media gateway 40 to the customer service representative PC 13.

In such a case, the customer service representative PC 13 transmits text data about the conversation content between the customer service representative and the customer to the support server 50, requesting a recommended response.

The support server 50 is connected to the customer service representative PC 13, analyzes the text received through the customer service representative PC 13, searches for related information from the knowledge DB 82, and provides searched information to the customer service representative PC 13.

The customer service representative PC 13 may automatically request the support server 50 to provide a recommended response for all conversations during a counseling process, or may display a UI on a screen and request the support server 50 to provide a recommended response according to the input of the customer service representative.

Accordingly, the customer service representative can respond to the customer's question during the voice call based on the response output to the customer service representative PC 13. In a state in which the customer and the customer service representative are on a call between the customer phone terminal 11 and the customer service representative terminal 12, the customer service representative can extract the customer's voice and convert the voice into text, and receive a recommended response from the support server (assistant server) 50 through the customer service representative PC 13 based on the text. The customer service representative can respond to the customer's question through the customer service representative terminal 12 based on the recommended response displayed on the customer service representative PC 13. Accordingly, the customer service representative can receive help through the recommended response of the support server (assistant server) 50 during the counseling with the customer.

The support server 50 includes a query classifier 51, a keyword search engine 54, a natural language search engine 52, a response generation engine 53, and a response generator 55.

The support server 50 receives the text converted from the voice call through the customer service representative PC 13 and recognizes the language of the text. For example, the support server 50 may recognize language by representations from using bidirectional encoder transformers (BERT) an being artificial intelligence language model as a pre-learning language model.

The support server 50 searches for information from the knowledge DB 82 based on text analysis to generate a response, and outputs the response through the customer service representative PC 13. The support server 50 analyzes the conversation content between the customer or the customer service representative through text analysis to determine the meaning included in the text, and generates a response for the meaning.

The support server 50 may select one response among a plurality of responses based on the search results, and output the selected response to the customer service representative PC 13. The support server 50 may also output the plurality of responses and recommend one of them.

In addition, the support server 50 may map the customer's question and response data derived for the question, and store the mapped data in the knowledge DB 82. The support server 50 may produce statistics on questions and responses. When an acknowledgement to the response output through the customer service representative PC 13 is received, the support server 50 may map acknowledgement data to response data and store the mapped data in the knowledge DB 82.

The support server 50 classifies the requested customer's conversation content into keywords, interrogative sentences, plain texts, and exclamation sentences through a query classifier, and when the classified content is not the keywords or the interrogative sentences, the support server 50 processes it as failure.

When the received data is classified as the keyword by the query classifier, the support server 50 receives a document recommended through a keyword search engine, and when the received data is classified as the interrogative sentence, the support server 50 receives a document recommended through a natural language search engine.

The support server 50 may use sentence bidirectional encoder representations from transformers (SBERT), which utilizes bidirectional encoder representations from transformers (BERT) being an artificial intelligence language technology, as a pre-learning language model.

The BERT is a pre-learning language model that learns from tens of billions of text data and vectorizes elements for understanding text, such as the context of sentences, components, and semantic similarities of words, in advance, and may be used in machine translation, machine reading comprehension, document summarization, sentiment analysis, conversation, and the like.

The support server 50 searches for documents related to the customer's question through the customer phone terminal 11 by using a sentence BERT (SBERT) model utilizing a BERT model and a machine reading comprehension (MRC) model being a machine reading comprehension model, and provides a service for selecting and recommending responses based on the search results.

The SBERT is a technology for embedding sentences into specific vector values that allow a computer to understand text according to the context and semantic characteristics thereof, and is used in various language technologies similarity measurement and clustering.

The machine reading comprehension (MRC) model being a machine reading comprehension model is a technology for extracting responses to questions requested by users from registered documents, and may use large-scale question-and-answer datasets recently released by various research institutes and companies.

When the recommended document is question-and-answer data (FAQ), the support server 50 immediately transmits the corresponding response to the customer service representative PC 13.

when the recommended document is a general document, the support server 50 generates several recommended responses from the response generator 55 through the MRC model, and transmits the generated recommended responses to the customer service representative PC 13. The customer service representative PC 13 may display the recommended document and the location information of the document on the screen and also display the list of recommended responses on the screen.

Accordingly, when the recommended responses are displayed through the customer service representative PC 13, the customer service representative proceeds with the counseling by voice or the like through the customer service representative terminal 12 connected to the customer phone terminal 11.

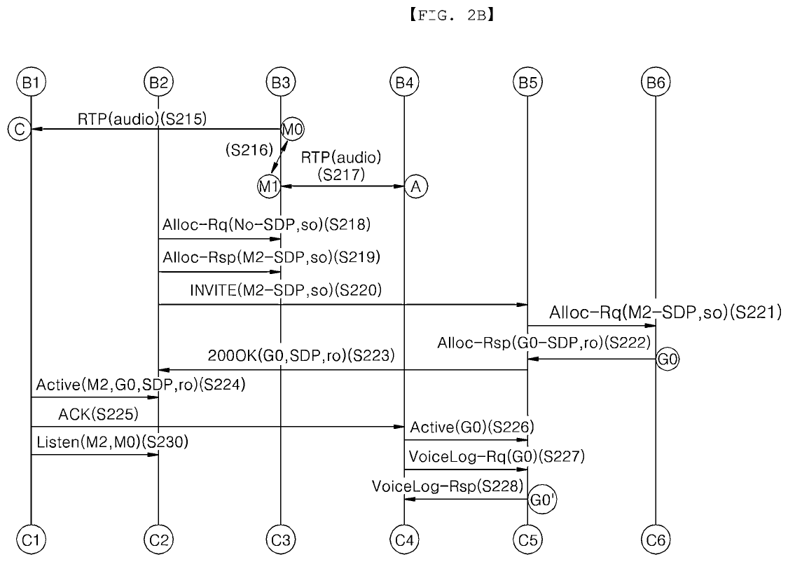

FIG. 2A, FIG. 2B, and FIG. 2C are flowcharts showing a process of transmitting voice in the intelligent response recommendation system for real-time voice counseling support according to an embodiment of the present disclosure.

As illustrated in FIG. 2A, FIG. 2B, and FIG. 2C, when a call between the customer phone terminal 11 and the customer service representative terminal 12 is connected, the call center system voice received through the customer service representative terminal 12 or the customer phone terminal 11 to the media gateway 40 through the media server 60.

When the customer phone terminal 11 sends a call to the representative number of the call center, including media information C-SDP, an invitation message INVITE is transmitted to the IP-PBX 32 (S201).

When the invitation message INVITE is received, the IP-PBX 32 requests the media server 60 to allocate a channel, including the terminal's media information C-SDP in a message Alloc-Rq (S202).

The media allocates one media M0 channel, negotiates media based on the terminal's media information (offer SDP)C-SDP and a media capacity (capability) supported by the media server 60, and generates an answer SDP (M0-SDP). In addition, the media server 60 transmits a response message Alloc-Rsp including the answer SDP to the IP-PBX 32 together with the channel allocation result (S203).

The IP-PBX 32 transmits, to the customer phone terminal 11, a message 200OK including M0-SDP in the response message Alloc-Rsp received from the media server 60 (S204).

When the message 200OK is received, the customer phone terminal 11 transmits an acknowledgement message ACK to the IP-PBX 32 (S205).

The IP-PBX 32 transmits an activation message Active M0 to the media server 60 in order to activate the M0 channel (S206).

When the activation message Active M0 is received, the media server 60 activates the M0 channel and exchanges voice data with the customer phone terminal 11. Since a counterpart channel is not connected yet, the media server 60 transmits silence to the customer phone terminal 11. In addition, the media server 60 transmits a ringback tone.

The IP-PBX 32 allocates one of a plurality of customer service representatives to a corresponding call through the CTI 33. In order to connect the channel of the customer service representative terminal 12 of the customer service representative to which the call has been allocated and the channel of the customer phone terminal 11, the IP-PBX 32 transmits a message Alloc-Rq without SDP to the media server 60 (S207), and requests allocation of one new channel.

When the message Alloc-Rq without SDP is received, the media server 60 allocates one M1 channel and generates an offer SDP (M1-SDP) based on the media capacity (capability) supported by the media server 63. The media server 60 transmits a message Alloc-Rsp including the offer SDP to the IP-PBX 32 together with the channel allocation result (S208).

The IP-PBX 32 transmits an invitation message INVITE including M1-SDP in the message Alloc-Rsp received from the media server 60 to the customer service representative terminal 12 (S209).

When the invitation message INVITE is received, the customer service representative terminal 12 negotiates media based on the offer SDP (M1-SDP) and the media capacity of the terminal, and generates an answer SDP (A-SDP)). The customer service representative terminal 12 transmits a message 200OK including the answer SDP to the IP-PBX 32 (S210).

When the message 200OK is received from the customer service representative terminal 12, the IP-PBX 32 transmits an active message Active including A-SDP to the media server 60 in order to activate the M1 channel (S211). In addition, the IP-PBX 32 transmits an acknowledgement message ACK to the customer service representative terminal 12 (S212).

Accordingly, the customer service representative terminal 12 (A) may transmit and receive voice data with the M1 channel of the media server 60.

The IP-PBX 32 transmits a listen message Listen to the media server 60 in order to share voice data between the M0 channel of the customer phone terminal 11 side and the M1 channel of the customer service representative terminal 12 side (S213 and S214). Accordingly, the M0 channel listens to the M1 channel and the M1 channel listens to the M0 channel.

The voice of the customer is transmitted to the customer service representative terminal 12 through the M1 channel via the M0 channel and the voice of the customer service representative is transmitted to the customer phone terminal 11 through the M0 channel via the M1 channel, so that a call between the customer and the customer service representative is established (S215 to S217).

In such a case, in order to transmit the voice data of the customer to the media gateway 40, the IP-PBX 32 transmits a message Alloc-Rq without SDP to the media server 60 (S218), and requests the media server 60 to allocate one new channel in sendonly mode.

When the allocation request message Alloc-Rq without SDP is received, the media server 60 allocates one M2 channel and generates an offer SDP (M2-SDP) in sendonly mode based on the media capacity (capability) supported by the media server 60. The media server 60 transmits an allocation response message Alloc-Rsp including the offer SDP to the IP-PBX 32 together with the channel allocation result (S219).

The IP-PBX 32 transmits an invitation message INVITE including M2-SDP in the message Alloc-Rsp received from the media server 60 to a session controller 41 of the media gateway 40 (S220).

When the invitation message INVITE is received, the session controller 41 of the media gateway 40 transmits an allocation request message Alloc-Rq including M2-SDP to a media controller 42 (S221).

The media controller 42 of the media gateway 40 negotiates media based on the received offer SDP (M2-SDP) and the media capability of the media controller 42 of the media gateway 40, and generates an answer SDP (G0-SDP) in recvonly mode G0. The media controller 42 transmits an allocation response message Alloc-Rsp including the answer SDP to the session controller 41 (S222).

When the allocation response message Alloc-Rsp is received from the media controller 42 of the media gateway 40, the session controller 41 of the media gateway 40 transmits a message 200OK including the G0-SDP to the IP-PBX 32 (S223).

When the message 200OK is received from the session controller 41 of the media gateway 40, the IP-PBX 32 transmits an active message Active including the G0-SDP to the media server 63 in order to activate the M2 channel (S224). In addition, the IP-PBX 32 transmits an acknowledgement message ACK to the session controller 41 of the media gateway 40 (S225).

In order to transmit the voice data of the customer to the media gateway 40, the IP-PBX 32 sends a listen message Listen to the media server 63 so that the M2 channel can hear the M0 channel (S230).

Accordingly, the voice of the customer is transmitted to the media controller 42 of the media gateway 40 through the M2 channel via the M0 channel (S231 to S233).

When the acknowledgement message ACK is received from the IP-PBX 32, the session controller 41 of the media gateway 40 transmits an active message Active to the media controller 42 of the media gateway 40 in order to activate the G0 channel (S226). The session controller 41 requests a voice log VoiceLog-Rq in order to convert the voice data of the customer received through the G0 channel into text (S227).

When the request for the voice log VoiceLog-Rq is received through the G0 channel, the media controller 42 of the media gateway 40 transmits a voice log response message VoiceLog-Rsp to the session controller 41 (S228). The media controller 42 converts the voice data of the customer received through the G0 channel into text through the STT 61 (S234 and S235).

In addition, in order to transmit the voice data of the customer service representative to the media gateway 40, the IP-PBX 32 transmits an allocation request message Alloc-Rq without SDP to the media server 60 to request allocation of one new channel in sendonly mode (S240).

When the allocation request message Alloc-Rq without SDP is received, the media server 60 allocates one channel M3. The media server 60 generates an offer SDP (M3-SDP) in sendonly mode based on the media capacity supported by the media server 60. The media server 60 transmits an allocation response message Alloc-Rsp including the offer SDP (M3-SDP) to the IP-PBX 32 together with the channel allocation result (S241).

The IP-PBX 32 transmits an invitation message INVITE including M3-SDP in the allocation response message Alloc-Rsp received from the media server 60 to the session controller 41 of the media gateway 40 (S242).

When the invitation message INVITE is received, the session controller 41 of the media gateway 40 transmits an allocation request message Alloc-Rq including M3-SDP to the media controller 42 of the media gateway 40 (S243).

The media controller 42 of the media gateway 40 negotiates media based on the received offer SDP (M3-SDP) and the media capability of the media controller 42 of the media gateway 40, and generates an answer SDP (G1-SDP) in a recvonly mode. The media controller 42 transmits an allocation response message Alloc-Rsp including the answer SDP to the session controller 41 (S244).

When the allocation response message Alloc-Rsp is received from the media controller 42 of the media gateway 40, the session controller 41 of the media gateway 40 transmits a message 200OK including G1-SDP to the IP-PBX 32 (S245).

When the message 200OK is received from the session controller 41 of the media gateway 40, the IP-PBX 32 transmits an active message Active including G1-SDP to the media server 63 in order to activate the channel M3 (S246). In addition, the IP-PBX 32 transmits an acknowledgement message ACK to the session controller 41 of the media gateway 40 (S247).

Accordingly, the voice of the customer is transmitted to the media controller 42 of the media gateway 40 through the channel M3 via the M1 channel (S251 to S255).

In order to transmit the voice data of the customer service representative to the media gateway 40, the IP-PBX 32 sends a listen message Listen to the media server so that the channel M3 can listen to the M1 channel (S251).

When the acknowledgement message ACK is received from the IP-PBX 32, the session controller 41 of the media gateway 40 transmits an active message Active to the media controller 42 of the media gateway 40 in order to activate the G1 channel (S248). The session controller 41 requests a voice log VoiceLog-Rq in order to convert the voice data of the customer service representative received through the G1 channel into text (S249).

When the request for the voice log VoiceLog-Rq is received through the G1 channel, the media controller 42 of the media gateway 40 transmits a message VoiceLog-Rsp to the session controller 41 (S250). The media controller 42 converts the voice data of the customer service representative received through the G1 channel into text through the STT 61 (S255 and S256).

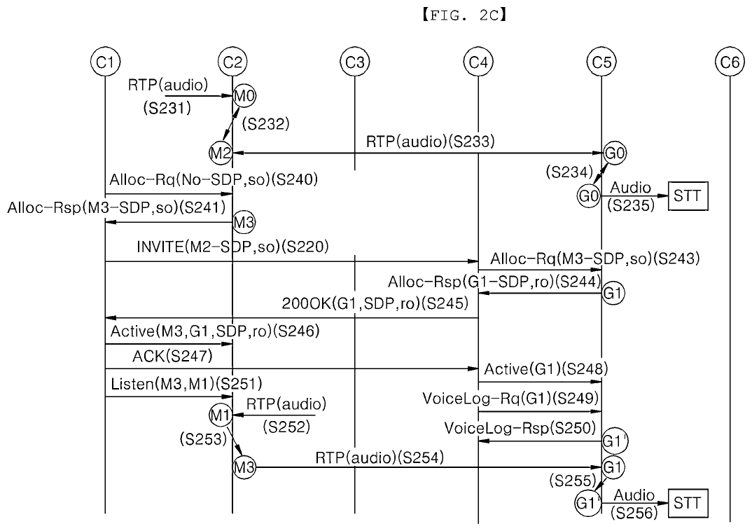

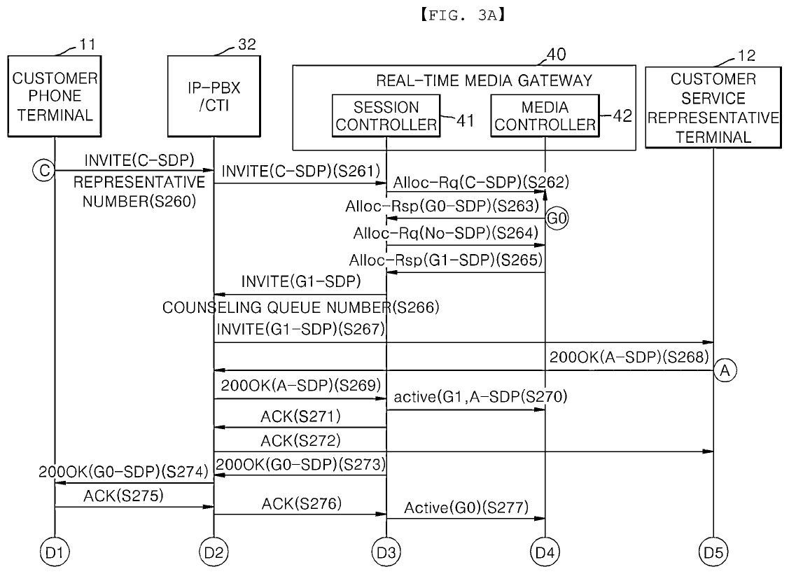

FIG. 3A and FIG. 3B are flowcharts illustrating a process of transmitting and sharing voice in the intelligent response recommendation system for real-time voice counseling support according to an embodiment of the present disclosure.

As illustrated in FIG. 3A and FIG. 3B, when the call center system makes a voice call between a customer and a customer service representative through a public switched telephone network, the call center system shares voice data of the customer through the media gateway 40.

The customer phone terminal 11 sends a call to the representative number of the call center system including its own media information C-SDP, and accordingly, an invitation message INVITE is transmitted to the IP-PBX 32 (S260).

When the invitation message INVITE is received, the IP-PBX 32 routes the invitation message INVITE including the terminal's media information C-SDP to the session controller 41 of the media gateway 40 (S261).

When the invitation message INVITE is received from the IP-PBX 32, the session controller 41 of the media gateway 40 requests the media controller 42 of the media gateway 40 to allocate a channel by transmitting an allocation request message Alloc-Rq including the C-SDP (S262).

When the allocation request message Alloc-Rq is received, the media controller 42 of the media gateway 40 allocates one media G0 channel and negotiates media based on the offer SDP C-SDP and the media capacity (capability) supported by the media controller 42 of the media gateway 40, and generates an answer SDP (G0-SDP). The media controller 42 transmits an allocation response message Alloc-Rsp including the answer SDP to the session controller 41 of the media gateway 40 together with the channel allocation result (S263).

In order to connect the customer service representative terminal 12, the session controller 41 of the media gateway 40 transmits an allocation request message Alloc-Rq to the media controller 42 of the media gateway 40, and requests allocation of one new channel (S264).

When the allocation request message Alloc-Rq without SDP is received, the media gateway 40 allocates one G1 channel and generates an offer SDP (G1-SDP) based on the media capacity (capability) supported by the media server 63. The media gateway 40 transmits an allocation response message Alloc-Rsp including the offer SDP to the session controller 41 of the media gateway 40 together with the channel allocation result (S265).

The session controller 41 of the media gateway 40 transmits an invitation message INVITE including G1-SDP in the allocation response message Alloc-Rsp received from the media controller 42 of the media gateway 40 to the IP-PBX 32 (S266). In such a case, the session controller 41 sends an incoming number to a customer service representative queue waiting number designated in the IP-PBX 32/CTI.

When the invitation message INVITE is received from the session controller 41 of the media gateway 40, the IP-PBX 32 receives a customer service representative distributed from the CTI and transmits an invitation message INVITE including G1-SDP to the customer service representative terminal 12 (S267).

When the invitation message INVITE is received, the customer service representative terminal 12 negotiates media based on the offer SDP (G1-SDP) and the media capability (capability) of the customer service representative terminal 12, and generates an answer SDP (A-SDP). The customer service representative terminal 12 transmits a message 200OK including the answer SDP to the IP-PBX 32 (S268).

When the message 200OK is received from the customer service representative terminal 12, the IP-PBX 32 transmits a message 200OK including A-SDP to the session controller 41 of the media gateway 40 (S269).

The session controller 41 of the media gateway 40 transmits an active message Active including A-SDP to the media controller 42 of the media gateway 40 in order to activate the G1 channel (S270). In addition, the session controller 41 transmits an acknowledgement message ACK to the IP-PBX 32 (S271).

When the acknowledgement message ACK is received from the session controller 41 of the media gateway 40, the IP-PBX 32 transmits an acknowledgement message ACK to the customer service representative terminal 12 (S272).

Accordingly, voice data is exchanged between the customer service representative terminal 12 (A) and the G1 channel of the media gateway 40 media controller 42.

When the line switching with the customer service representative terminal 12 is completed (after an acknowledgement message ACK is transmitted to the IP-PBX 32, the session controller 41 of the media gateway 40 transmits a message 200OK including G0-SDP to the IP-PBX 32 in order to complete the line switching with the customer phone terminal 11 (S273).

When the message 200OK is received from the session controller 41 of the media gateway 40, the IP-PBX 32 transmits a message 200OK including G0-SDP to the customer phone terminal 11 (S274).

When the message 200OK is received, the customer phone terminal 11 transmits an acknowledgement message ACK to the IP-PBX 32 (S275).

When the acknowledgement message ACK is received from the customer phone terminal 11, the IP-PBX 32 transmits an acknowledgement message ACK to the session controller 41 of the media gateway 40 (S276).

When the acknowledgement message ACK is received from the IP-PBX 32, the session controller 41 of the media gateway 40 transmits an active message Active to the media controller 42 of the media gateway 40 in order to activate the G0 channel (S277).

Accordingly, voice data is exchanged between the customer phone terminal 11 (C) and the G0 channel of the media controller 42 of the media gateway 40.

The session controller 41 of the media gateway 40 transmits a listen message Listen to the media controller 42 of the media gateway 40 in order to share voice data between the G0 channel of the customer phone terminal 11 side and the G0 channel of the customer service representative terminal 12 side (S278). The G0 channel listens to the G1 channel and the G1 channel listens to the G0 channel (S279).

The voice of the customer is transmitted from the customer phone terminal 11 to the customer service representative terminal 12 through the G1 channel via the G0 channel and the voice of the customer service representative is transmitted to the customer phone terminal 11 through the G0 channel via the G1 channel, so that a call between the customer and the customer service representative is established (S280 to $282).

When the voice connection between the customer and the customer service representative is completed, the session controller 41 of the media gateway 40 requests the media controller 42 of the media gateway 40 to provide a voice log VoiceLog-Rq in order to convert the voice data of the customer received through the G0 channel into text (S283).

When the request for the voice log VoiceLog-Rq is received through the G0 channel, the media controller 42 of the media gateway 40 transmits a voice log response message VoiceLog-Rsp to the session controller 41 (S284). The media controller 42 transmits the voice data of the customer received through the G0 channel to the STT 61 so that voice data is converted into text (S285 to S287).

Likewise, in order to convert the voice data of the customer service representative received through the G1 channel into text, the session controller 41 of the media gateway 40 requests the media controller 42 of the media gateway 40 to provide a voice log VoiceLog-Rq (S288).

When the request for the voice log VoiceLog-Rq is received through the G1 channel, the media controller 42 of the media gateway 40 transmits a voice log response message VoiceLog-Rsp to the session controller 41 (S290). The media controller 42 transmits the voice data of the customer service representative received through the G1 channel to the STT 61 so that voice data is converted into text (S291 to S293).

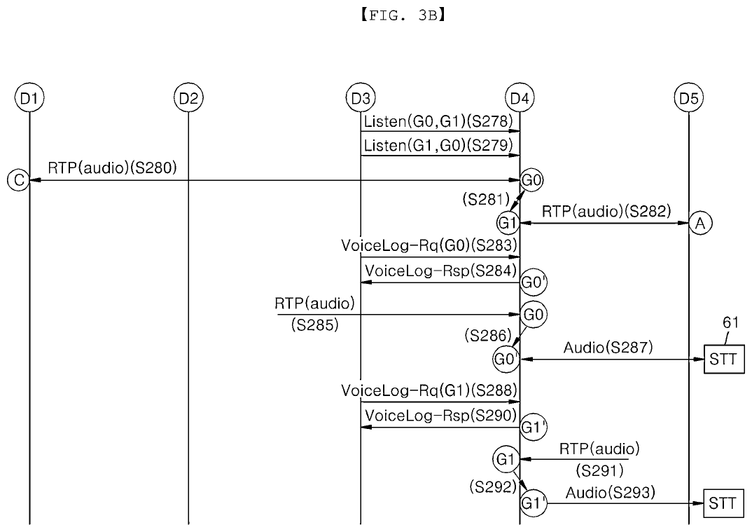

FIG. 4 is a diagram for reference in explaining a channel-specific voice data processing process of the intelligent response recommendation system for real-time voice counseling support according to an embodiment of the present disclosure.

As illustrated in FIG. 4, the media controller 42 of the media gateway 40 requests the STT 61 to recognize voice from received voice data, and transmits the corresponding response result to the text relay server 62.

A G0 channel 310 includes an RTP interface module (RTP IF 0) 311 and a jitter module (Jitter 0) 312. When RTP packets 313 corresponding to an amount corresponding to a minimum length set by the Jitter 0 (312) are received, the RTP IF 0 (311) transmits the RTP packets 313 to the Jitter 0 (312).

The Jitter 0 (312) first checks a retransmission packet, a sequence number error packet, and a timestamp error packet and buffers the packets for a set time. When no packets are received until the set time lapses, the Jitter 0 (312) is in an underflow situation occurs and returns to an initial state. On the other hand, when a packet reception speed is higher than a packet processing speed, packets are gradually accumulated in the Jitter 0 (312). When the length of the accumulated packets is larger than a set maximum length, the Jitter 0 (312) is in an overflow situation, deletes all packets in a buffer, and receives packets again from the beginning. Packets having passed through the jitter buffering process are converted into a Linear PCM 16-bit audio codec through a voice decoding process and are immediately written to a unique timeslot of each Gn channel.

A G1 channel 320 has one unique timeslot and may read or write data through a virtual bus 350. The read operation of each Gn channel is possible not only in its own timeslot but also in the timeslots of other Gn channels.

However, the Gn channel can read only one timeslot and is not able to simultaneously read two or more timeslots. Each Gn channel can write data in only a unique timeslot. Since data moving on the virtual bus 350 includes a linear PCM 16-bit audio codec having passed through a jitter module (Jitter 1) 322, data read by the Gn channel is encoded and packaged as an RTP packet 323 and transmitted through a RTP interface module (RTP IF 1) 321 by bypassing the Jitter 0 (312).

A G0′ channel 330 includes a voice activity detector module (VAD 0′) 331, an STT interface (STT IF 0′) 332, and a relay server interface (Text IF 0′) 333, and a G1′ channel 340 includes a voice activity detector module (VAD 1′) 341, an STT interface (STT IF 1′) 342, and a relay server interface (Text IF 1′) 343. Each Gn channel can read only timeslots of the same channel number.

The VAD 0′ (331) and the VAD 1′ (341) detect whether voice data is silent. This is for lowering a transmission rate in a silent section of voice data transmitted to the STT 61, and through this, the start and end times of a customer or customer service representative's speech may be determined. The VAD 0′ (331) and the VAD 1′ (341) transmit voice data corresponding to the speech section to the STT IF 0′ (332) and the STT IF 1′ (342).

The data read by the G0′ channel 330 and the G1′ channel 340 from the timeslot is as long as the PTime of an RTP packet received through the Gn channel. This may be different from the transmission unit frame length required by the STT 61. The STT IF 0′ (332) and the STT IF 1′ (342) need to buffer the data by the transmission unit frame length required by the STT 61 and then transmit the buffered data to the STT 61.

The STT IF 0′ (332) and the STT IF 1′ (342) request a connection in a TCP mode being a stateful protocol required by the STT 61, and continuously transmits voice data after a connection acceptance response from the STT 61. Whenever a voice recognition and text conversion result message is received from the STT 61, the result is transmitted to the relay server 62, and the transmission protocol and standard follow the REST API defined by the relay server 62.

Meta information transmitted to the STT 61 needs to include voice codec information, sample rate information, language code information, and the like. Meta information received from the STT 61 needs to include timestamp (offset from a voice start point), recognition continuation/end information, and the like.

When a voice log VoiceLog-Rq start request is received from the session controller 41 of the media gateway 40 to the G0 channel 310 and the G1 channel 320, the text interface 333 and 343 of the Gn channel calls the call start API of the text relay server 62. The call start API includes the customer phone terminal 11 number transmitted to the G0 channel and customer/customer service representative identifier information.

The Text IF 0′ (333) and the Text IF 1′ (343) call the call content API of the text relay server 62 whenever the voice recognition and text result messages are received from the STT IF 0′ (332) and the STT IF 1′ (342). The call content API includes a number of the customer phone terminal 11, customer/customer service representative identifier information, timestamp information, and call content. When a voice log VoiceLog-Rq stop request is received from the session controller 41 of the media gateway 40 through the Gn channel, the Text IF 0′ (333) and the Text IF 1′ (343) of the G0′ channel 330 and the G1′ channel 340 call a call termination API of the text relay server 62. The call termination API includes the number of the customer phone terminal 11 and the customer/customer service representative identifier information.

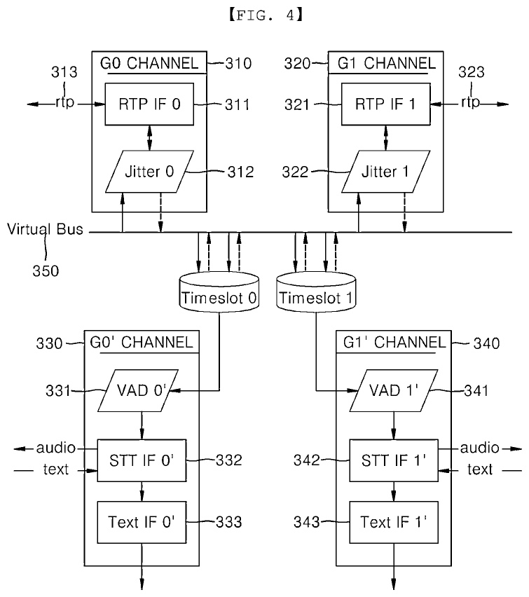

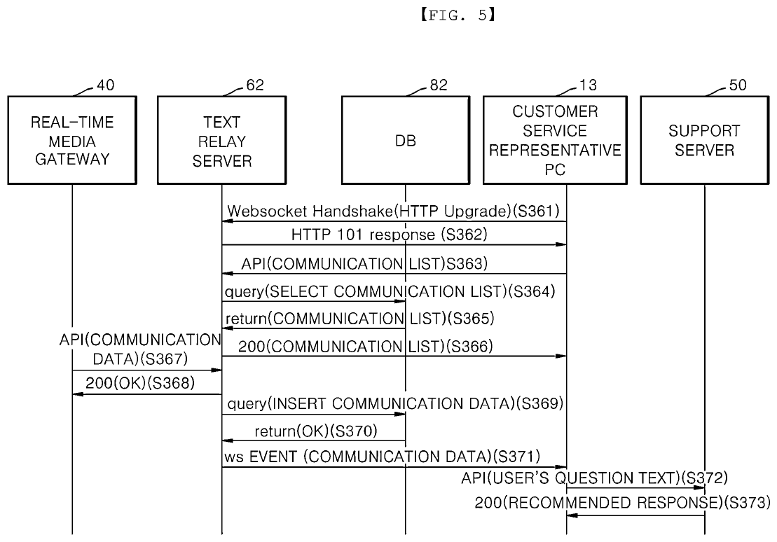

FIG. 5 is a flowchart illustrating a recommendation response processing process of the intelligent response recommendation system for real-time voice counseling support according to an embodiment of the present disclosure.

As illustrated in FIG. 5, the media gateway 40, the text relay server 62, the database server, the customer service representative PC 13, and the support server 50 request a recommended response to a customer question through mutual data processing and receive the recommended response.

The customer service representative PC 13 requests a handshake to the text relay server 62 by using a web socket (WS) HTTP upgrade header (S361).

The text relay server 62 responds with 101 switching protocols to complete a connection with the customer service representative PC 13 being a computer of the customer service representative, and the customer service representative PC 13 receives data from the text relay server 62 through a WS event from this time point (S362).

The customer service representative PC 13 requests the text relay server 62 to provide a communication list, for example, call content, call status, the number of the customer phone terminal 11, customer/customer service representative identifier information, timestamp information, and data, through API communication (S363).

The text relay server 62 requests (Selects) the communication list from the DB 81 and receives a response (S364). The text relay server 62 transmits the received communication list to the customer service representative PC 13 (S366). The customer service representative PC 13 displays the received communication list on the screen.

The media gateway 40 transmits the call content that the customer service representative is counseling, call status, the number of the customer phone terminal 11, customer/customer service representative identifier information, timestamp information, and data to the text relay server 62 through the API communication (S367).

The text relay server 62 stores the received data in the DB 81 (S369), and when a response is received from the DB 81 (370), the text relay server 62 transmits the received response to the customer service representative PC 13 through a WS event (S371).

The customer service representative PC 13 displays the data (user question text), which is transmitted from the text relay server 62 through the WS event, on the screen in real time, and calls the API of the support server 50 to receive recommendations for documents and responses (S372 and S373).

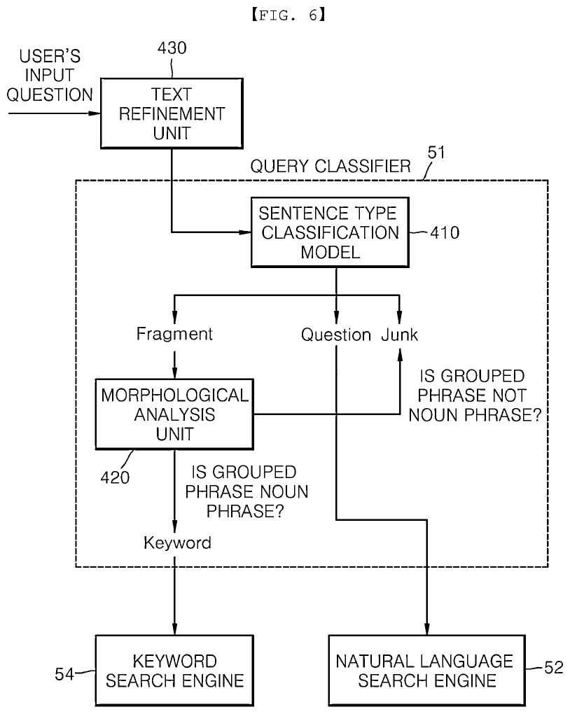

FIG. 6 is a diagram for reference in explaining an input query classification process of the intelligent response recommendation system for real-time voice counseling support according to an embodiment of the present disclosure.

The support server 50 includes the query classifier 51, the keyword search engine 54, the natural language search engine 52, the response generation engine 53, and the response generator 55.

As illustrated in FIG. 6, when a user's question is input, the query classifier 51 receives, text as input, refined through a text refinement unit 430. The text refinement unit 430 performs a function of refining unnecessary text such as email, URL, letters in parentheses, various special characters, emoticons, emojis, spaces before and after letters, and the refined text is used as input to the query classifier.

The text refined through the text refinement unit 430 is used as input to a sentence type classification model 410 of the query classifier 51.

According to an embodiment of the present disclosure, the sentence type classification model 410 refers to a model fine-tuned through a sentence type classification dataset based on a robustly optimized BERT pretraining approach (RoBERTa) being a pre-trained language model, but may also include various pre-trained language models such as BERT, ELECTRA, BART, T5, and GPT.

The sentence type classification model 410 uses a pre-learning model including a 768-dimensional embedding vector size, a 768-dimensional hidden vector size, a total of 6 hidden layers, and a total of 12 multi-head attention heads for fine-tuning learning. However, in the pre-learning model, the embedding vector size, the hidden vector size, the number of layers, and the number of multi-head attention heads may be selected as arbitrary values according to a learner's choice rather than fixed values.

The sentence type classification dataset used for fine-tuning learning of the sentence type classification model 410 includes a total of 7 sentence types (fragment, statement, question, command, rhetorical question, rhetorical command, and intonation-dependent utterance).

The sentence type classification model 410 is fine-tuned through the RoBERTa model being the pre-learning language model described above and the sentence type classification dataset, and the learned model is configured as Transformers, a PyTorch-based tokenizer, and a model, and is stored in a cloud server (not illustrated).

The fine-tuned sentence type classification model 410 includes a model and a tokenizer. The sentence type classification model 410 receives refined text from the text refinement unit 430 as input, and performs an encoding process through the stored tokenizer on the input text.

The sentence type classification model 410 returns three output values input_ids, token_type_ids, and attention mask as the results of the encoding process. The input_ids is the result of converting text into numerical values, the token_type_ids is a sentence distinction value, and the attention mask is a combination of 0 and 1 and includes information on whether each token is affected by an operation during model learning.

The input_ids, the token_type_ids, and the attention mask returned by the tokenizer are input to the sentence type classification model. For example, when a user's question such as “what the weather today?” is input to the tokenizer, the result of {‘input_ids: [0, 3822, 5792, 2116, 15682, 2182, 35, 2], ‘token_type_ids: [0, 0, 0, 0, 0, 0, 0, 0], ‘attention mask’: [1, 1, 1, 1, 1, 1, 1, 1]} is output. The output from the tokenizer is used as the input of the model.

The sentence type classification model 410 having received the result of the tokenizer as input performs token embedding and position embedding processes on the input via an embedding layer. Subsequently, the sentence type classification model 410 performs self-attention and multi-head attention operations, performs feedforward network, residual connection, and layer normalization processes, and finally outputs probability values for each sentence type through a softmax layer.

The output value of the sentence type classification model 410 is a probability value for each sentence type, and includes probability values for a total of 7 sentence types as described above. For example, the output value of the sentence type classification model for the user input such as “What is the weather today?” is [[{‘label’: ‘fragment’, ‘score’: 2.8306711101322435e-05}, {‘label’: ‘statement’, ‘score’: 0.00011472464393591508}, {‘label’: ‘question’, ‘score’: 0.9985309839248657}, {‘label’: ‘command’, ‘score’: 0.0005991582875140011}, {‘label’: ‘rhetorical question’, ‘score’: 0.0004276987165212631}, {‘label’: ‘rhetorical command’, ‘score’: 0.00012860454444307834}, {‘label’: ‘intonation-dependent utterance’, ‘score’: 0.00017061365360859782}]].

Finally, the sentence type classification model 410 returns a sentence type with the highest probability value in the output value.

As described above, the sentence type classification model 410 returns probability values for a total of seven sentence types, but sentence types except fragment and question are all classified as junk, and one of fragment, question, and junk is finally returned.

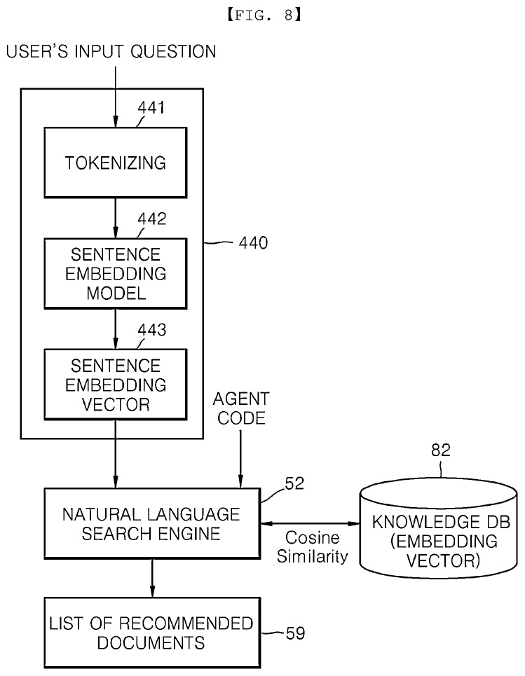

When the return value by the sentence type classification model 410 is a question, the return value is input to the natural language search engine 52. The natural language search engine 52 performs document recommendation utilizing the natural language search engine of FIG. 8 to described below.

When the return value by the sentence type classification model 410 is a fragment, the user input question is input to a morphological analysis unit 420 and a morphological analysis process is performed.

When the return value by the sentence type classification model 410 is a junk, an empty result value is returned without any subsequent process.

The morphological analysis unit 420 tokenizes the user input by using a morphological analyzer based on a word dictionary. The morphological analysis unit 420 performs part-of-speech (POS) tagging and dependent phrase analysis on each token to acquire part-of-speech information and dependent relationship information on each token.

Based on the part-of-speech information and dependent relationship information acquired through the POS tagging and dependent phrase analysis, the morphological analysis unit 420 groups words that are tied to the last noun token in a dependent relationship through the dependent phrase analysis when the part-of-speech of the last token is one of a common noun (NNG), a proper noun (NNP), or a dependent noun (NNB).

When the grouped phrase is a noun phrase, the morphological analysis unit 420 finally classifies the sentence type as a keyword and applies the classified keyword to the keyword search engine 54. The keyword search engine 54 performs document recommendation utilizing the keyword search engine.

When the grouped phrase is not a noun phrase, the morphological analysis unit 420 finally reclassifies the sentence type as a junk and returns an empty result value without performing any subsequent processes.

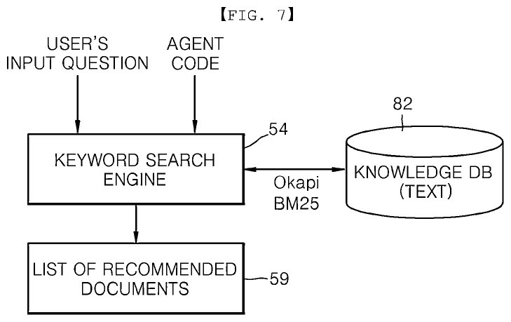

FIG. 7 is a diagram for reference in explaining a document recommendation process through keyword search of the intelligent response recommendation system for real-time voice counseling support according to an embodiment of the present disclosure.

As illustrated in FIG. 7, the keyword search engine 54 performs a document recommendation process based on keyword search on the user input question finally classified as a keyword through the query classifier 51 in FIG. 6 described above.

The keyword search engine 54 receives the user input question and an agent code that can identify an agent. The keyword search engine 54 retrieves a text document, in which the agent code is stored as a key value, from the second database (knowledge DB) 82 based on the agent code. In addition, the keyword search engine 54 measures the similarity between the user input question and the retrieved text document through a keyword-based search algorithm.

For example, the keyword search engine 54 may measure the similarity between the input question and the retrieved text document by using Okapi BM25 being a Google's search algorithm. The Okapi BM25 algorithm is one of modified algorithms of a term frequency-inverse document frequency (TF-IDF) algorithm. The term frequency (TF) is the total frequency of a specific word in a document, and the inverse document frequency (IDF) is a reciprocal of the frequency of the document in which the specific word occurs. As a result, a rare word not occurring in many documents and occur frequently in a specific document has a higher score.

The following equation 1 is a calculation expression for a similarity score between keywords and documents of Okapi BM25 being a keyword-based search algorithm.

$$score ( D , Q ) = {\sum }_{i = 1}^{n} IDF ( {q}_{i} ) \cdot \frac{f ( {q}_{i} , D ) \cdot ( {k}_{1} + 1 )}{f ( {q}_{i} , D ) + {k}_{1} \cdot ( 1 - b + b \cdot \frac{\vert D \vert}{avgdl} )} \qquad Equation 1$$

In equation 1 above, score(D, Q) denotes the BM25 similarity score of a keyword Q for a document D.

$$f ( {q}_{i} , D ) + {k}_{1} \cdot ( 1 - b + b \frac{\vert D \vert}{avgdl} )$$

is a calculation expression for calculating TF. In the calculation expression above, f(qi, D) denotes the frequency of a keyword qi in the document D. IDF(qi) is a calculation expression for calculating IDF, and denotes a reciprocal of a document including the keyword qi.

As a result, by applying a document length weight to the TF-IDF described above, even though there are two keywords with the same TF-IDF score, the Okapi BM25 considers the lengths of documents including each keyword and gives a higher score to a keyword included in the shorter document.

Finally, the keyword search engine 54 calculates the similarity score from the user input question, the document filtered through the agent code in the knowledge DB 82, and the keyword search algorithm (for example, Okapi BM25), and finally returns a document with the highest similarity score.

FIG. 8 is a diagram for reference in explaining the document recommendation process through natural language search of the intelligent response recommendation system for real-time voice counseling support according to one embodiment of the present disclosure.

As illustrated in FIG. 8, the natural language search engine 52 performs a document recommendation process based on natural language search on the user input question finally classified as a question through the query classifier 51 as described above in FIG. 6. The user input question is converted into a sentence embedding vector 443 by a sentence embedding model 442.

The user input question is converted into the sentence embedding vector 443 by the sentence embedding model 442.

The present disclosure describes an example in which the sentence embedding model 442 is fine-tuned based on the pre-trained RoBERTa model, but this is merely an example and the sentence embedding model may include all models based on a sentence BERT architecture.

The sentence BERT architecture basically receives two sentences as input, converts the sentences into embedding vectors, and then performs a pooling process in which all token vectors of the sentences are reduced into one vector. The sentence vectors pooled into one vector are learned through a Siamese network, and a similarity loss value is calculated through a Triplet loss function.

The Siamese network calculates the similarity between two input sentences by using similarity calculation techniques such as cosine similarity, Manhattan, and Euclidean distance, for embedding vector values for the two input sentences. The Siamese network performs learning while adjusting a network weight so that the similarity is large when the two sentences are sentences of the same class, and adjusting the network weight so that the similarity is small when the two sentences are sentences of different classes. In such a case, the Siamese network uses the Triplet loss function as a loss function.

The following equation 2 is a calculation expression for the Triplet loss function defined in the Sentence Embeddings using Siamese BERT-Networks of the paper published in 2019.

$$max ( ‖ {s}_{a} - {s}_{p} ‖ - ‖ {s}_{a} - {s}_{n} ‖ + ∈ , 0 ) \qquad Equation 2$$

In equation 2 above, f(x) denotes a neural network operation for generating a feature vector, Sa denotes a comparison sentence vector, sₚ denotes a sentence vector of the same class, and sₙ denotes a sentence vector of a non-identical class.

According to equation 2 above, the difference between the comparison sentence vector and the sentence vector of the same class needs to be smaller than the difference between the comparison sentence vector and the sentence vector of the non-identical class, and the loss function is calculated so that the distance between similar sentence vectors is decreased and the distance between dissimilar sentence vectors is increased.

According to an embodiment of the present disclosure, the model is fine-tuned to 8 batch sizes and 6 epoch sizes, and the fine-tuned learned model is configured as a Transformers, a Pytorch-based tokenizer, and a model and stored in a cloud server (not illustrated).

The user input question may be converted into the sentence embedding vector 443 through the learned sentence embedding model 442. For example, the user input question such as “What is the weather today?” is converted into a sentence embedding vector of a total of 768 dimensions through the sentence embedding model.

The natural language search engine 52 receives the sentence embedding vector 443 converted through the sentence embedding model 442 and the agent code that can identify the agent.

The natural language search engine 52 retrieves the document embedding vector 443 stored with the agent code as a key value from the second database (knowledge DB) 82 based on the agent code.

The natural language search engine 52 measures the similarity between the sentence embedding vector input to the natural language search engine 52 and the document embedding vector retrieved from the knowledge DB 82 through the cosine similarity calculation formula. The natural language search engine 52 finally returns a document text of a document embedding vector with the highest similarity to the sentence embedding vector as a result value.

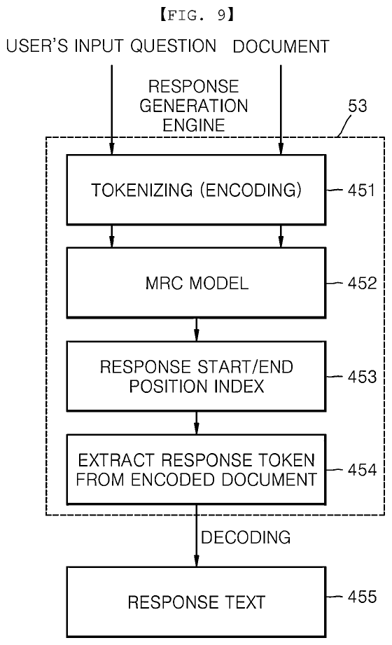

FIG. 9 is a diagram for reference in explaining a response data generation process of the intelligent response recommendation system for real-time voice counseling support according to an embodiment of the present disclosure.

As illustrated in FIG. 9, the response generation engine 53 performs a process of generating a response most related to the user's question from the document text returned from the natural language search engine 52 in FIG. 8 described above.

An MRC model used in the response generation engine 53 refers to a model fine-tuned through a question-answer dataset based on the bidirectional encoder representations from transformers (BERT) being the known pre-learning language model. However, the MRC model may also include various pre-trained language models such as RoBERTa, ELECTRA, BART, T5, and GPT.

The pre-trained model used for fine-tuning the MRC model includes a 768-dimensional embedding vector size, a 768-dimensional hidden vector size, a total of 12 hidden layers, and a total of 12 multi-head attention heads. However, the embedding vector size, the hidden vector size, the number of layers, and the number of multi-head attention heads may be selected as arbitrary values according to a learner's choice rather than fixed values.

The MRC model has been fine-tuned through the pre-trained language model BERT described above and the question-answer dataset, and the learned model is configured as Transformers, a PyTorch-based tokenizer, and a model, and is stored in the cloud server.

The fine-tuned MRC model is a concept including a model and a tokenizer. First, the user input question and the document text returned from the natural language search engine 52 in FIG. 8 are input together to the tokenizer and subjected to an encoding process.

The results of the encoding process are returned as three output values: input_ids, token_type_ids, and attention mask. The input_ids is the result of converting text into numerical values, the token_type_ids is a sentence distinction value, and the attention mask is a combination of 0 and 1 and includes the result of whether each token is affected by an operation during model learning.

The input_ids, the token_type_ids, and the attention mask returned by the tokenizer are input to the MRC model. For example, when a user input question such as “How many days will it take to get a refund?” is input to the tokenizer, the result of {‘input_ids: [2, 15045, 2073, 1077, 2210, 5511, 2200, 3662, 2470, 18119, 35, 3], ‘token_type_ids: [0, 0, 0, 0, 0, 0, 0, 0, 0, 0, 0, 0], ‘attention mask’: [1, 1, 1, 1, 1, 1, 1, 1, 1, 1, 1, 1, 1]} is output. The result output for the user input question and document text through the tokenizer is used as the input of the MRC model.

The MRC model having received the result of the tokenizer as input performs token embedding and position embedding processes on the input via an embedding layer. Subsequently, the MRC model performs self-attention and multi-head attention operations, performs feedforward network, residual connection, and layer normalization processes, and finally predicts a token from the last output layer through the softmax layer after going.

The MRC model returns position index values corresponding to the start and end of the response as output values. The MRC model extracts a response token from the encoded document text through the returned position index values, and then returns a response text through a decoding process.

For example, when a question “How many days will it take to get a refund?” is input to the MRC model and the response “Within 14 days after purchase” is located at the 5th to 15th positions in the document text, the returned start position index is tensor([5]), the end position index is tensor([15]). When tokens in a corresponding position index range are extracted from the encoded document text through this, token values of tensor([4625, 1943, 3909, 2210, 5511] are extracted. Finally, when the extracted token values are subjected to a decoding process of converting the token index values into text through the tokenizer, the response “Within 14 days after purchase” is generated.

The support server 50 performs requests and acknowledgements with the customer service representative PC 13, which is the customer service representative's computer, as a RESTful API. For all input queries input to the customer service representative PC 13, the support server 50 is immediately called and an acknowledgement corresponding to each input query is returned. The acknowledgement of the support server 50 basically includes a list of recommended documents and a list of recommended responses, and both the list of recommended documents and the list of recommended responses may have one or more result values, but when there is no appropriate document or response, an empty result value may be output.

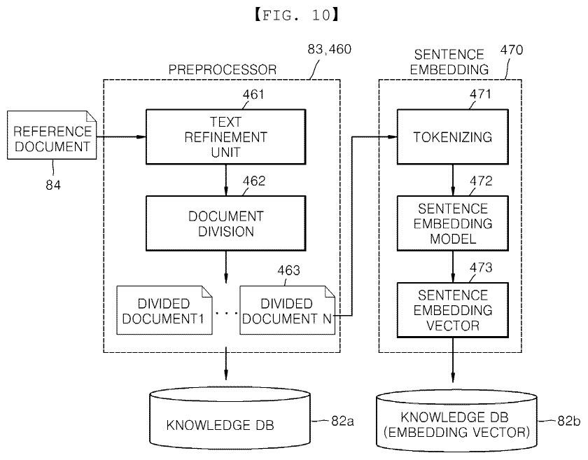

The list of recommended documents includes a list of divided documents divided by the preprocessor 83 in FIG. 10, the ID value of an original document corresponding to the list of divided documents, document meta information, and the cosine similarity score for each document. For example, when a document of Wikipedia searched for as “Republic of Korea” is stored in the knowledge DB 82 according to the procedure of FIG. 10 and then a question such as “Where does Republic of Korea belong as a member country?” is input, the following output value is generated as a result of the list of recommended documents.

{“documents”: [{“id”: . . . , “text”: “Republic of Korea is one of the countries with the highest level of democracy in Asia as indicated by the Democracy Index survey published by the Economist, which ranked 23^{rd} in 2019 with a score of 8.0. In addition, Republic of Korea is also a member of the Group of 20 (G20), the Organization for Economic Co-operation and Development (OECD), the Development Assistance Committee (DAC), the Paris Club, and the like. [8]”, “score”: 0.4176899999999323, “meta”: {“doc_title”: “Wikipedia-Republic of Korea.txt”, (omitted)}, (omitted)}], (omitted)}

In the “documents” field, there are recommended documents in an array format, sorted by the “score” field. The first value in the array denotes a document with the highest similarity score, the “text” field d includes a document section most related to the input question, the “score” field includes a cosine similarity score between the input question and a corresponding document, and the “meta” field includes information related to the document such as a document title and a document type.

The list of recommended responses is generated from the response generation engine 53 in FIG. 9 described above. First, the list of recommended responses described above and the input question are used as input to the response generation engine 53.

The response generation engine 53 tokenizes the input question and the list of recommended documents received as input and uses them as input to the machine reading comprehension (MRC) model, and the machine reading model extracts a response corresponding to the input question from the list of all recommended documents received. For example, when the result of the list of recommended documents received by receiving the Wikipedia document searched for “Republic of Korea” described in the example above is input to the response generation engine 53, the response generation engine 53 generates the following output value as the result of the list of recommended documents.

{“answers”: [{“answer”: “the Group of 20 (G20), the Organization for Economic Co-operation and Development (OECD), the Development Assistance Committee (DAC), and the Paris Club, and the like”, “score”: 0.8811326026916504, “offset_start”: 106, “offset_end”: 162, “document_id”: “ca347f7e7a3255bd3d26b1fe9dd57ca4”, “meta”: {“_split_id”: 3, “doc_title”: “Wikipedia-Republic of Korea.txt”, (omitted)}}, (omitted)], (omitted)}

In the “answers” field, there are recommended answers in an array format, sorted by the “score” field. The first value in the array denotes an answer with the highest machine reading score, the “answers” field includes an answer extracted from the document, the “score” field includes the machine reading score, the “offset_start” and “offset_end” fields include the start and end positions of an answer in the document, the “document_id” field includes the unique ID value of a document from which an answer is extracted, and the “meta” field includes information related to the document from which the answer is extracted.

As a result, when the support server 50 is called from the customer service representative PC 13 together with an input question, the list of recommended documents and the list of recommended responses are converted into a JSON format and then transmitted to the customer service representative PC 13 as a response. Subsequently, the customer service representative PC 13 outputs, on the screen, the list of recommended documents through the “documents” field and the list of recommended responses through the “responses” field based on the response result.

FIG. 10 is a diagram for reference in explaining a reference document storage process of the intelligent response recommendation system for real-time voice counseling support according to an embodiment of the present disclosure.

As illustrated in FIG. 10, a reference document 84 is a flowchart in which it is stored in the knowledge DB 82 through the preprocessor 83 (460) and sentence embedding 470.

The input reference document 84 is first subjected to the process of text refinement 461 and document division 462 through the preprocessor 83, and then is stored in the knowledge DB 82 in the form of original text 82a.

The text refinement unit 461 in the preprocessor 83 improves the quality of the text by performing special characters, emoticons, emojis, unnecessary spaces, Korean consonants and vowels, and capitalization processing, and the like, and effectively performs the sentence embedding 470 to be performed later through a sentence embedding model 472.

Subsequently, the reference document 84 refined through the text refinement unit 461 is subjected to the process of document division 462.

The purpose of document division is to match the document length to a maximum input token length of the sentence embedding model and machine reading model to be performed later. In the case of the pre-learning language model based on BERT or RoBERTa used in the sentence embedding model and machine reading model, an input sequence with a maximum length of 512 tokens is received as input, and in the case of an input sequence exceeding the length of 512 tokens, there is a limitation that tokens after 512 tokens are truncated. In addition, when the document length is too long, since it consumes a greater amount of operation and time in the sentence embedding and response generation process, it is important to appropriately divide the document length.

The preprocessor 83 divides the document based on 100 phrases for the input reference document. In such a case, in order not to lose context information of the divided document, 10 overlapping phrases in the preceding and following sentences are included, and in order to prevent the sentence from being cut off in the middle, the document is divided only based on the sentence. N documents 463 divided in this way are stored in the knowledge DB 82 as a Json-based text original form 82a.

An additionally divided document is stored in the form of a sentence embedding vector for subsequent document similarity search. The sentence embedding model 472 of FIG. 10 is the same model as the sentence embedding model used in the natural language search engine 52 of FIG. 8 described above.

Similar to the document vectorization process of the natural language search engine 52, the divided document is tokenized (471) by a tokenizer and then input to the sentence embedding model 472 and an embedding vector 473 is output. Subsequently, each embedded document vector is stored in the knowledge DB 82 in the form of an embedding vector 82b.

Although the present disclosure has been described with reference to the embodiments illustrated in the drawings, the embodiments of the disclosure are for illustrative purposes only, and those skilled in the art will appreciate that various modifications and other equivalent embodiments are possible from the embodiments. Thus, the true technical scope of the present disclosure should be defined by the following claims.

### INDUSTRIAL APPLICABILITY

The present disclosure provides an intelligent response recommendation system for real-time voice counseling support and a method thereof that can derive and recommend a response appropriate for a customer's question by converting the customer's question into text through voice recognition, classifying the text into keywords and natural language based on a language model, and searching the keywords and natural language through a search engine to derive a response.

1. An intelligent response recommendation system for real-time voice counseling support, comprising:
a first terminal to which voice of a user is input;
a call center system that allocates a second terminal to the first terminal to connect a call between the first terminal and the second terminal, and extracts voice data from a voice call between the first terminal and the second terminal;
a media gateway that performs circuit switching with the call center system and shares the voice data;
a STT server that converts the voice data received from the media gateway into text data;
a third terminal that is connected to the second terminal, and receives the text data and displays response data corresponding to the text data in a state in which the call between the first terminal and the second terminal is connected; and
a support server that analyzes the text data received from the third terminal to recognize a language, generates the response data corresponding to the language recognized from the text data, and transmits the response data to the third terminal.

2. The intelligent response recommendation system for real-time voice counseling support of claim 1, further comprising:
a relay server connected to the media gateway and transmitting the text data converted by the STT server to the third terminal,
wherein the media gateway transmits the voice data to the STT server to request text conversion, and transmits the text data converted by the STT server to the relay server.

3. The intelligent response recommendation system for real-time voice counseling support of claim 1, wherein the STT server analyzes the voice data, converts customer voice data input through the first terminal into customer text data, converts voice data of a customer service representative input through the second terminal into counselor text data, and transmits the text data.

4. The intelligent response recommendation system for real-time voice counseling support of claim 1, wherein the support server analyzes a meaning included in the text data, searches for information on the text data, and generates the response data based on search results.

5. The intelligent response recommendation system for real-time voice counseling support of claim 4, wherein the support server generates a recommended response based on a search result corresponding to the meaning included in the text data among the search results, and transmits the recommended response to the third terminal as the response data.

6. The intelligent response recommendation system for real-time voice counseling support of claim 4, wherein when a document recommended according to a search result for a question included in the text data is included in the preset question-response data, the support server transmits the response data for the question to the third terminal.

7. The intelligent response recommendation system for real-time voice counseling support of claim 4, wherein when a document recommended according to a search result for a question included in the text data is a general document, the support server generates the response data comprising a plurality of responses and transmits the response data to the third terminal.

8. The intelligent response recommendation system for real-time voice counseling support of claim 1, wherein the support server maps a question included in the text data and the derived response data, stores the mapped data in a database, and calculates statistics on the question and a response.

9. The intelligent response recommendation system for real-time voice counseling support of claim 8, wherein when an acknowledgement for the response data is received, the support server matches the acknowledgement to the response data and stores the matched data in the database.

10. The intelligent response recommendation system for real-time voice counseling support of claim 1, wherein the support server comprises:
a query classifier that classifies a sentence type of data into one of a keyword, an interrogative sentence, a plain text, and an exclamation sentence based on analysis results of the text data;
a keyword search engine that searches for data classified into the keyword by the query classifier and recommends a document;
a natural language search engine that searches for data classified into the interrogative sentence by the query classifier and recommends a document;
a response generation engine that extracts a response corresponding to a meaning included in the text data from the document recommended by one of the keyword search engine and the natural language search engine; and
a response generator that generates the response data based on the response extracted by the answer generation engine.

11. The intelligent response recommendation system for real-time voice counseling support of claim 1, wherein the support server uses sentence bidirectional encoder representations from transformers (SBERT) being an artificial intelligence language model as a pre-learning language model, embeds sentences into specific vector values understandable by a computer in accordance with contextual and semantic characteristics of data included in the text data, measures a similarity between the sentences, and recognizes a language of the text data.

12. The intelligent response recommendation system for real-time voice counseling support of claim 1, wherein the support server uses a sentence BERT (SBERT) model being a language model and a machine reading comprehension (MRC) model being a machine reading comprehension model, searches for a document corresponding to a question or a keyword included in the text data, and generates response data based on search results.

13. An operation method of an intelligent response recommendation system for real-time voice counseling support, comprising:
a step of extracting voice data for a voice call by connecting a first terminal and a second terminal through a communication network;
a step of converting the voice data into text data;
a step of transmitting the text data to a third terminal connected to the second terminal;
a step in which the support server receiving the text data from the third terminal analyzes the text data and recognizes a language;
a step of searching data for a question or a keyword included in the text data according to a language recognition result;
a step of generating response data based on search results; and
a step in which the third terminal receives and displays the response data.

14. The operation method of an intelligent response recommendation system for real-time voice counseling support of claim 13, wherein the step of recognizing a language comprises:
a step of refining unnecessary text from the text data;
a step of classifying a sentence type for a sentence or a word included in the text data; and
a step of analyzing morphemes of the text data.

15. The operation method of an intelligent response recommendation system for real-time voice counseling support of claim 13, wherein the step of recognizing a language comprises:
a step of analyzing the text data and classifying the data into one of a keyword, an interrogative sentence, a plain text, and an exclamation sentence; and
a step of ignoring data other than the keyword and the interrogative sentence and analyzing next data.

16. The operation method of an intelligent response recommendation system for real-time voice counseling support of claim 15, wherein the step of searching data comprises:
a step of recommending a document by searching for data classified into the keyword; and
a step of recommending a document by searching for data classified into the interrogative sentence.

17. The operation method of an intelligent response recommendation system for real-time voice counseling support of claim 13, wherein in the step of generating response data, a recommended response is generated based on a search result corresponding to a meaning included in the text data among a plurality of search results.

18. The operation method of an intelligent response recommendation system for real-time voice counseling support of claim 13, wherein in the step of generating response data, when a document recommended according to the search result is a preset question-and-answer data, a response corresponding to the question is generated as the response data.

19. The operation method of an intelligent response recommendation system for real-time voice counseling support of claim 13, wherein in the step of generating response data, when a document recommended according to the search result is a general document, the response data comprising a plurality of responses is generated.

20. The operation method of an intelligent response recommendation system for real-time voice counseling support of claim 13, further comprising:
a step in which the support server maps the question included in the text data and the derived response data and storing the mapped data in a database;
a step of, when an acknowledgement for the response data is received, matching the acknowledgement to the response data and storing the matched data; and
a step of calculating statistics on the question and a response.
